(19) United States
(12) Patent Application Publication
(10) Pub. No.: US 2024/0157237 A1
(43) Pub. Date: May 16, 2024

(54) AUGMENTED VISUAL GAME SYSTEM

(71) Applicant: Tom Appleton, Ontario (CA)

(72) Inventor: Tom Appleton, Ontario (CA)

(21) Appl. No.: 18/389,131

(22) Filed: Nov. 13, 2023

Related U.S. Application Data
(60) Provisional application No. 63/383,656, filed on Nov. 14, 2022.

(51) Int. Cl. A63F 13/52; A63F 13/837; G06T 19/00

(52) U.S. Cl. CPC A63F 13/52; A63F 13/837; G06T 19/006

(57) ABSTRACT

An augmented reality game system is disclosed that allows a user to throw or shoot a real object into a pervious screen wherein the real object traverses the pervious screen and seems to disappear and is replaced by an impact animation or image where the interaction of the real object with a projected target is simulated. A projector provides the projection of a target image. Location detection adjacent the pervious screen determines an impact location of a traverse object and communicates the location to a computer. The computer generates a reaction image or impact animation where the traverse object scores a hit or a common location with the projected target. In one embodiment, a soft material throwing axe can be thrown at a simulated projected wooden target and the system produces an impact animation simulating a real axe embedded in the projected wooden target. In another embodiment, a shooting gallery can simulate a glass bottle broken on impact, or animals, or other targets. Light and sound effects can increase the immersion of the augmented reality game.

### CROSS-REFERENCE TO RELATED APPLICATIONS

Priority is claimed to Provisional Patent Application No. 63/383,656 filed on Nov. 14, 2022, which is incorporated in its entirety.

### BACKGROUND OF THE INVENTION

### Field of the Invention

The present general inventive concept is directed to an apparatus for projection of a target image on a target surface and allows a projectile to pass through the target surface while projecting an image, animation, or video of a virtual projectile onto the target surface to simulate interaction of the projectile and the target. Various conventional and novel interactions can be portrayed while creating a more efficient user experience.

### Description of the Related Art

The prior art discloses known target games such as darts or axe throwing. It is known to throw sharp darts or sharp axes at a target. Sharp objects can embed themselves into a target. However, such activity is dangerous and safety precautions and supervision are needed to provide these activities to customers in a family entertainment center, or allow children to play such games. Shooting galleries suitable for entertainment often utilize a light gun rather than a true projectile so that shooting, for example bottles, does not result in broken glass. Shooting galleries often utilize a short reaction or animation to let the user know that the target has been hit. This technology is not suitable to games like axe throwing. What is needed is a system that combines the physical feel of throwing an item like an axe, dart, or flying disk, with the safety of a thrown projectile that is safe. The system should provide visual feedback of the accuracy or result of the thrown object to a user to increase user satisfaction and simulate the real action of throwing an object.

What is needed is an augmented reality target system that combines real objects with a projector that shows the results of each user's actions on the target surface and creates a safe version of a shooting gallery or axe throwing arena with augmented reality impact animations to enhance the user experience.

### SUMMARY OF THE INVENTION

It is an aspect of the present invention to provide an augmented reality system for receiving a traverse object through a projected target on a pervious screen, record the impact location, and produce an impact animation to provide a result to a user. The above aspects can be obtained by providing an augmented reality game system comprising a target system and a projector system where the target system comprises a pervious screen disposed within a target cabinet and a detector frame disposed within said target cabinet and adjacent said pervious screen, and where the projector system comprises a computer in communication with a projector, and said computer provides an image signal to said projector, and said projector projects a projected target image upon said pervious screen; said pervious screen comprises a plurality of contiguous elastic members; and said detector frame determines an impact location of a traverse object contacting said pervious screen.

Another embodiment provides for multiple target areas to provide both targets and impact detection to provide a larger field of targets for a user. These aspects can be obtained by a game system comprising: a target cabinet and a computer; a first detector frame disposed within said target cabinet and in communication with said computer; a second detector frame disposed within said target cabinet and in communication with said computer; a pervious screen positioned in front of said first detector and said second detector; a projector connected to said computer and configured to produce a projected target image comprising a first target and a second target on said pervious screen wherein a first target is displayed over said first detector frame and a second target is displayed over said second detector frame; wherein said first detector frame can detect an impact location of a traverse object when coinciding with said first target and said second detector frame can detect said impact location of said traverse object when coinciding with said second target; and said computer generates an impact animation for display at said impact location.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a perspective view of a projector system in an embodiment of the invention.

FIG. 2 is a perspective view of a projector system in an embodiment of the invention.

FIG. 3 is an exploded perspective view of a target system in an embodiment of the invention.

FIG. 4 is a perspective view of a pervious screen in an embodiment of the invention.

FIG. 5 is a perspective view of an assembled target system in an embodiment of the invention.

FIG. 6 is a perspective view of a target system receiving a projected target and a traverse object in an embodiment of the invention.

FIG. 7 is a perspective view of a target system displaying a reaction image in an embodiment of the invention.

FIG. 8 is a perspective view of a target system suited to receive an item with a horizontal shape in an embodiment of the invention.

FIG. 9 is a perspective view of a target system comprising multiple detector frames in an embodiment of the invention.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to an apparatus for combining a pervious target screen and a projector to provide an interactive augmented reality game.

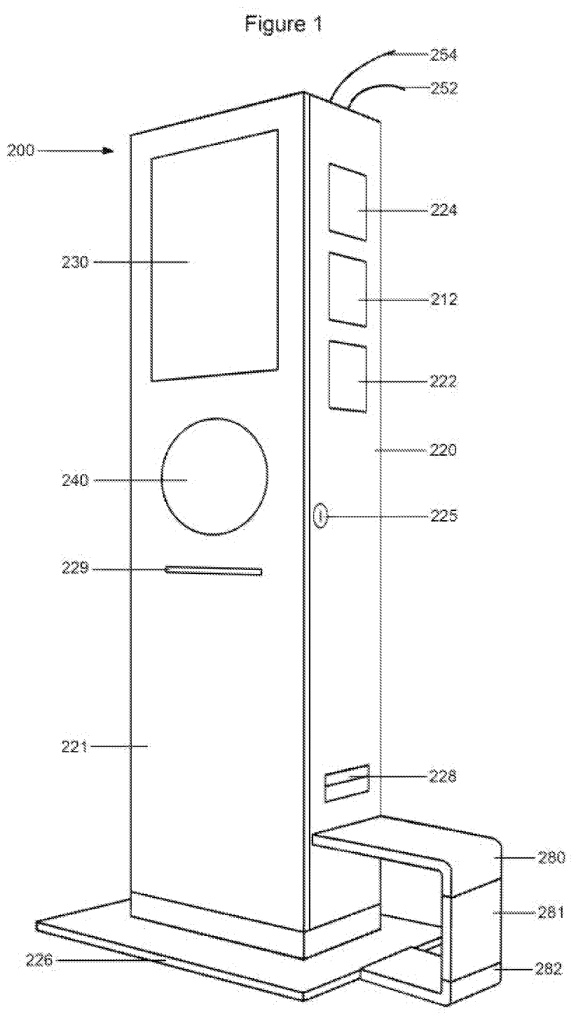

The present invention provides a projected target 140 by a projector system 200 that provides for interactive virtual games where a user shoots or throws a real physical object at a projected target 140 and the system records the placement of the physical object as it contacts the target. A physical object can be thrown or shot and can be an axe, dart, disk, ball, or other object. Herein, any object that travels towards target system 100 can be considered a traverse object when it encounters pervious screen 120. Numerous target images can be produced as well as target “hit” images or animations. Darts can be thrown at a virtual dart board, balls can be shot at a bottle, shooting gallery, or flying ducks, etc. FIG. 1 presents a perspective view of a projector system 200. Projector cabinet 220 can have openings to accommodate an inlet vent 222 and outlet vent 224. Each vent can accommodate a vent fan (not shown) as needed to force inlet and outlet air flow for cooling as needed. Projector cabinet 220 can comprise first shelf 242 and second shelf 244 to support components of projector system 200. Computer 250 is contained internally and can be connected to both electricity and the target system 100. Computer 250 can be a windows based mini computer, for example a computer with 16 GB RAM and running Windows 11. Suitable mini computers can be purchased at Amazon.com. Touchscreen interface 230 can be mounted within access door 221 and accessible to a user to select a game, report scoring results, and provide a user interface. Projector 210 is contained within projector cabinet 220 and is directed at pervious screen 120 to create projected target 140. Projector 210 can be selected from available projectors. In one particular embodiment, an Epson EX3280 3 chip projector is utilized that produces XGA resolution (1024×768 pixels in 4:3 aspect ratio) and 3,600 lumens of color and white brightness. Other projectors can be employed in the spirit of the invention. A variety of different images can be provided by computer 250 and projector 210 including variations of a projected target 140 that appears to be a paper target, a painted target, or a wooden log for use in an axe throwing game. In other embodiments, other target images can be projected including animals (birds, ducks) or objects (bottles, plates). Impact animations can be provided by the computer 250 such as a broken bottle or an embedded axe. A power cord 252 provides electric power and a communication cord 254 provides connectivity to target system 300 and can be a USB cable, ethernet cable, or other cable type used for communication.

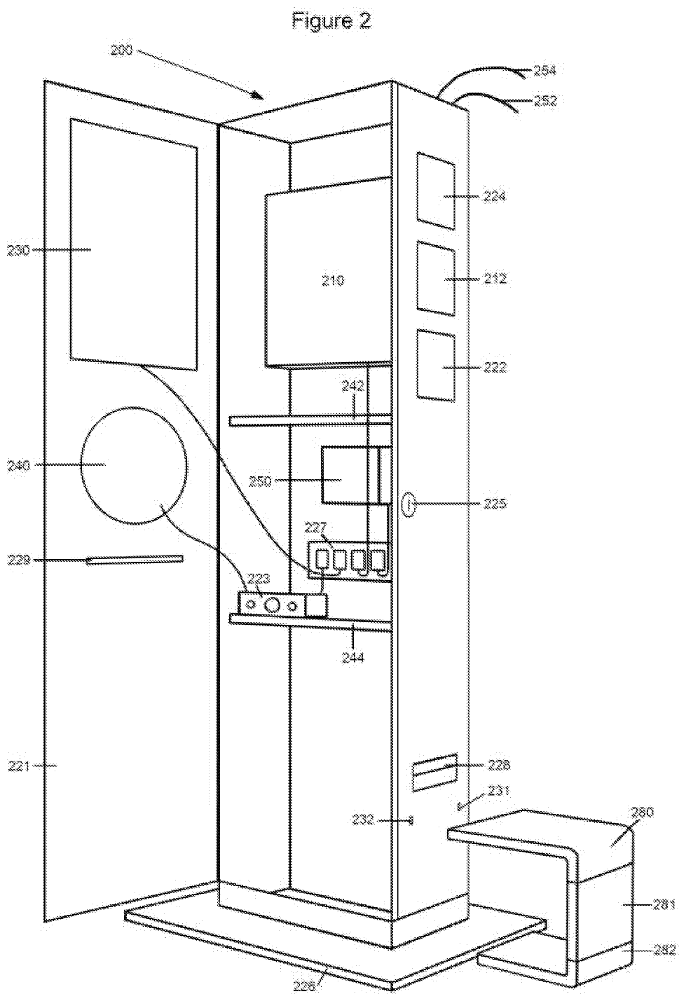

FIG. 2 presents a perspective view of the projector cabinet. Projector 210 can be positioned behind projector window 212 to allow the image to be projected forward towards the target cabinet. Base 226 supports the stable position of the projector cabinet 220 and can be connected to an optional seat 280 in an embodiment of the invention. Speaker 240 can be connected to computer 250 or alternately to touchscreen interface 230, or audio amplifier 223, and produce sounds to inform the user by confirming inputs or make celebratory sounds upon successful actions, add a soundtrack to the playing of a game, or make other sounds. Access door 221 can be hinged and opened to access the electronics within the projector cabinet 220 and can be secured with lock 225. Projector cabinet 220 can comprise a handle 228 to assist in movement. Light bar 229 can be synchronized with sounds and player actions to accentuate sounds and animations to increase the interactive experience of using the system. Successful user actions can be highlighted with lights and sounds to accompany an impact animation 142.

Power strip 227 can be located within the projector cabinet 220 and provide electrical power for the elements of the system including projector 210, touchscreen interface 230, computer 250, and audio amplifier 223. Power cords and connections are not numbered. Additional power and communication connections can be utilized as is known in the art including USB, ethernet, and wireless communications. Audio amplifier 223 can process audio signals from computer 250 and output signals to speaker 240 to confirm user actions on touchscreen interface 230 with sounds and to emphasize various actions of playing games using the system of the invention. Seat 280 can be constructed of several pieces including seat support 281 and seat base 282. In an embodiment, seat 280 can be secured to the structure by conventional threaded attachment through first seat opening 231 and second seat opening 232.

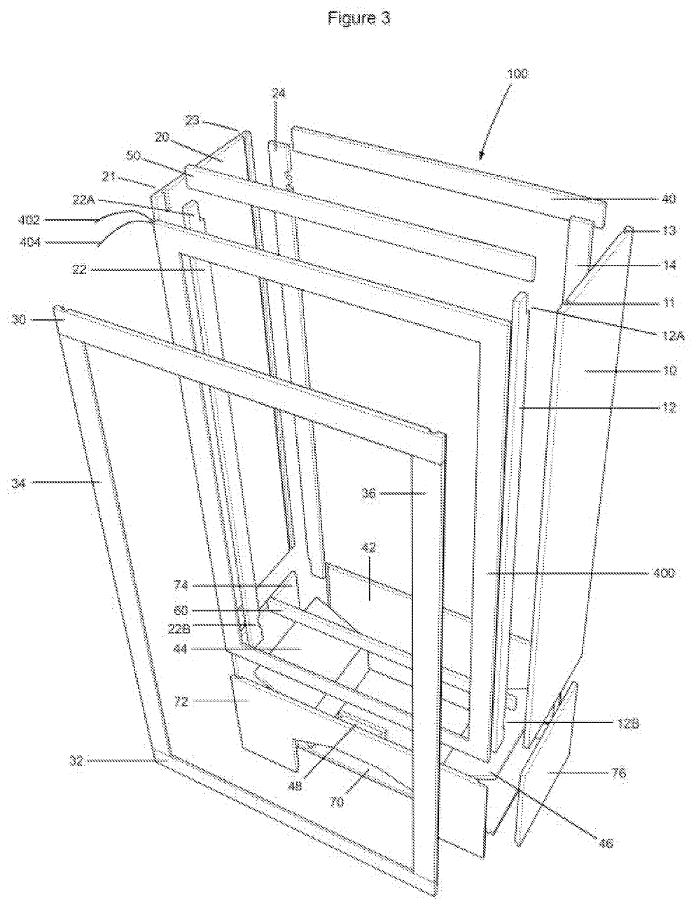

Target cabinet 100 is shown in FIG. 3 and comprises structural elements to provide a stable device suited to receive and return a thrown object or projectile fired from a gun. The target cabinet comprises features to receive and retain a top screen rail 50 and a bottom screen rail 60 to provide a pervious screen 120 to facilitate an augmented reality experience of allowing an object to pass the pervious screen 120 and project a reaction image or impact animation 142 to highlight the impact location or position where the traverse object encountered the projected target 140 on the pervious screen 120. In one particular embodiment, the target cabinet is built as shown in the exploded view of FIG. 3. Right side panel 10 can comprise right rail receiver 11 and right rear groove 13. One end of top screen rail 50 can be inserted in right rail receiver 11. Right support post 14 can be situated in right rear groove 13. Right frame support 12 can comprise first top rail notch 12A positioned adjacent right rail receiver 11 to precisely retain top screen rail 50 in a desired location and can comprise first bottom rail notch 12B to retain bottom screen rail 60. Similarly left side panel 20 can comprise left rail receiver 21 and left rear groove 23. Left frame support 22 can comprise second top rail notch 22A and second bottom rail notch 22B. Left support post 24 is configured for engagement with left rear groove 23. The front of the target cabinet provides a frame and a target opening to allow traverse objects to pass into the cabinet. Frame elements top frame 30, bottom frame 32, left frame 34, and right frame 36 as shown define a rectangular target opening (not numbered). Further structural support is provided by rear frame 40 and rear base panel 42. When objects enter target cabinet 100, they are directed back out towards the user by sloped elements with the help of gravity. Left divertor 44 and right divertor 46 are sloped toward the center of the cabinet. At the bottom, return slide 70 is angled towards the front of the device. As used herein, the front of the target system faces the user. Front base panel 72 comprises an opening for traverse objects to exit the cabinet. Left base panel 74 and right base panel 76 complete the structural bottom of the target cabinet 100. Cleat 48 connects bottom frame 32 to front base panel 72.

Detector frame 400 is shown positioned between the frame elements (30, 32, 34, 36) and the pervious screen 120. One detector frame 400 suitable for use is the ShadowSense optical position frame produced by Baanto International Ltd. and viewable at www.Baanto.com. Other position detectors are compatible with the spirit of the invention. The Baanto detector utilizes a series of infrared LEDs positioned around three edges of a rectangular frame shown in the embodiment of FIG. 3 as detector frame 400. Detector frame 400 comprises a number of light sensors positioned along the side of the frame that does not house infrared LEDs. When an object is present in, or passing through, the detector frame 400, a shadow is cast by the traverse objects and the LEDs that is detected by the multiple light sensors. The position of the object can then be calculated and positively determined by geometry based on which light sensors are in the shadow of the traverse object. Infrared LED's and infrared detectors utilize a spectrum not visible to the human eye. The manner of detection is not readily apparent to the user adding a sense of magic or immersion as the thrown object disappears and the impact animation 142 appears. The Shadowsense Pro can calculate a position within two millimeters. Frame communication cord 402 can connect computer 250 with detector frame 400. Frame power cord 404 can provide electric power to detector frame 400.

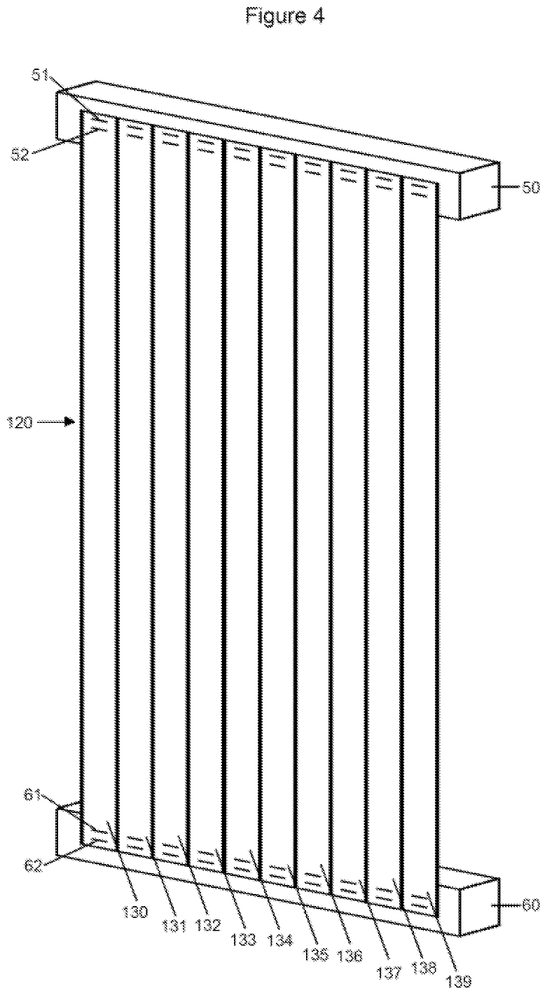

FIG. 4 shows a pervious screen 120 in an embodiment of the invention. Elastic straps can be used to create a surface that is static for receiving a projected image and also pervious for allowing the passage of a traverse object. In a particular embodiment, elastic straps of approximately one inch in width are employed and positioned next to each other to establish a continuous surface comprised of disparate parts or discrete elements. Pervious screen 120 preferably covers the target opening in the target cabinet and can comprise a plurality of elastic straps, bands, or ribbons placed adjacent to each other to provide a flat, resilient surface. Elastic straps 130 through 139 are shown in parallel position in FIG. 4. In one particular embodiment, woven elastic straps are utilized. One suitable source is Cansew Inc. that sells a product at www.cansew.com comprising a polyester wrap with a rubber core, and the strap maintains its width when stretched. In an embodiment of the invention, elastic straps are attached to top screen rail 50 and bottom screen rail 60. In an embodiment suited for receiving a projected target 140, the elastic straps are generally white in color. In an embodiment, elastic straps are cut to a length of 63 inches and then stapled to top screen rail 50 at elastic strap first end and stapled to bottom screen rail 60 at elastic strap second end as shown in FIG. 4. First elastic strap 130 is shown stapled at elastic strap first end with first top fastener 51 and second top fastener 52 to top screen rail 50. First elastic strap 130 is also shown stapled at elastic strap second end to bottom screen rail 60 using first bottom fastener 61 and second bottom fastener 62. In a similar manner, the other elastic straps can be attached to the screen rails utilizing fasteners. More staples, such as three or more, or less staples can be used at each end of each elastic strap in the spirit of the invention. Shown in FIG. 4, first elastic strap 130, second elastic strap 131, third elastic strap 132, fourth elastic strap 133, fifth elastic strap 134, sixth elastic strap 135, seventh elastic strap 136, eighth elastic strap 137, ninth elastic strap 138, and tenth elastic strap 139 are shown attached at a first end to top screen rail 50 and attached at a second end to bottom screen rail 60. The plurality of contiguous elastic members shown in FIG. 4 are situated adjacent to each other so that when viewed from the front of target system 100, they present a smooth surface, preferably white, that is suitable for receiving a projected image from projector system 200. Elastic bands or loops can also be used that encircle top screen rail 50 and bottom screen rail 60 to provide a pervious screen 120.

Target system 100 can be configured so that top screen rail 50 is disposed in right rail receiver 11 and left rail receiver 21, and bottom screen rail 60 is retained in first bottom rail notch and 12B and second bottom rail notch 22B. In an embodiment, the screen rails can be held securely so that the plurality of contiguous elastic members are stretched about three inches in length. With a starting length of about 63 inches, this represents an extension or stretching of about 5%. Providing tension to the elastic straps (for example 3% to 6% stretching in length) helps to maintain a flat surface that is also resilient with movement of any of the straps being returned or corrected back to the flat, even configuration that makes up pervious screen 120.

Pervious screen 120 is suited to receive a projected target 140. When a traverse object is thrown at, shot at, or otherwise approaches pervious screen 120, the plurality of elastic straps 130 through 139 easily flex, bend, and move to allow the passage of the object. In this way, an object can be thrown at the pervious screen 120 and projected target 140 that does not alter or modify pervious screen 120 and leaves it suited for the next attempt by the user. Woven elastic straps are durable, but can be replaced in case one is broken by playing the game or activity.

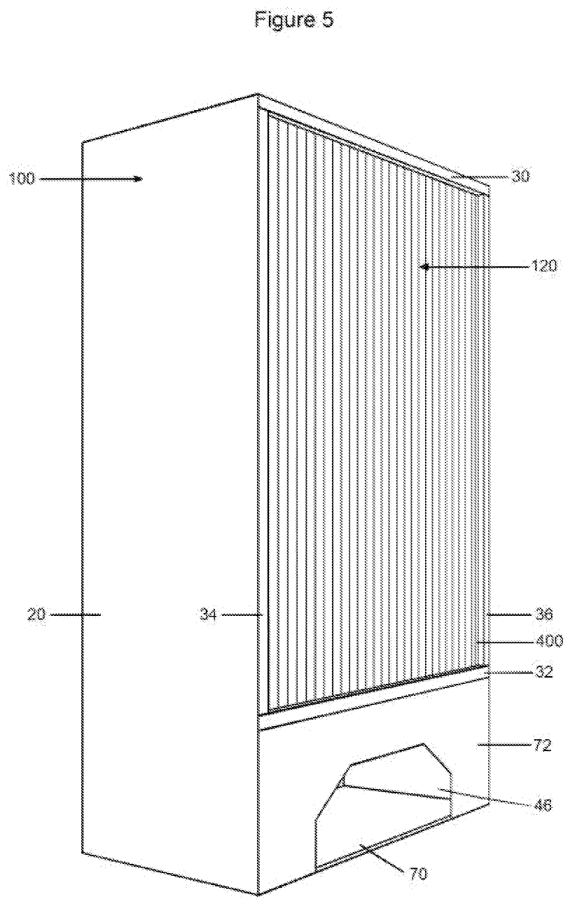

FIG. 5 shows the assembled target system 100 with detector frame 400 positioned interior to right frame 36 and in front of the pervious screen 120. In this way, traverse objects can be sensed by detector frame 400 before the plurality of elastic straps are moved which would create a large area of shadow or obstruction and lead to low accuracy of location detection by detector frame 400. With detector frame 400 positioned just inside the frame elements of the cabinet, the position of the thrown or shot traverse object can be detected accurately.

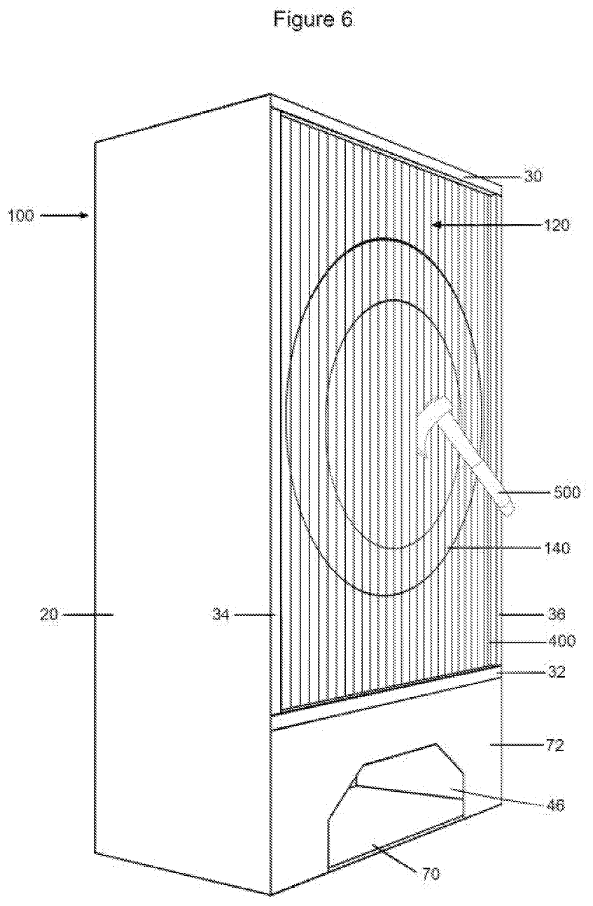

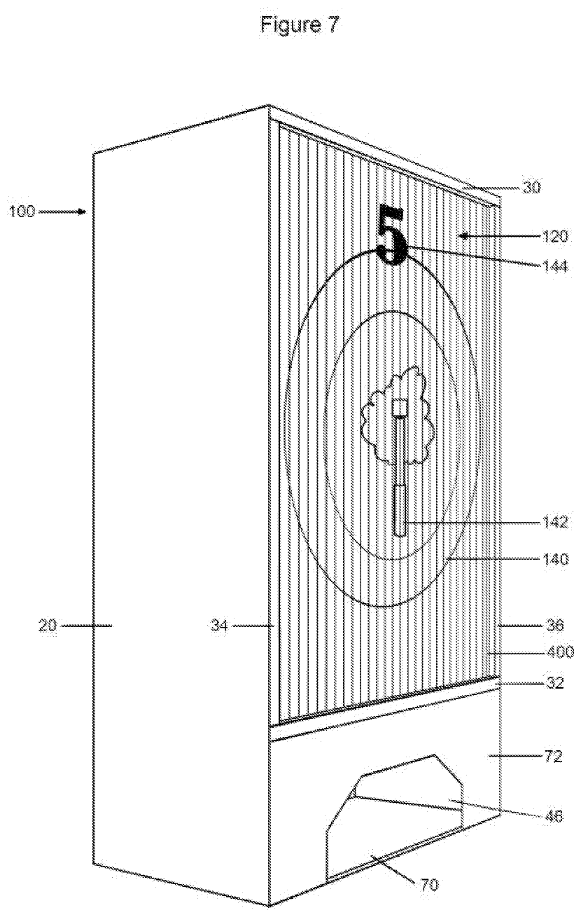

In one particular embodiment, foam axes representing replicas of throwing axes can be utilized by a user to be thrown at projected target 140 on pervious screen 120. The replicas can be foam or plastic and colored to be realistic while not being sharp, heavy, or dangerous. FIG. 6 shows a thrown axe 500 pass through pervious screen 120. Detector frame 400 detects the position of axe 500, thrown by a user, as it encounters projected target 140 on pervious screen 120. Target system 100 can be connected with a projector system 200 by electronic means through frame communication cord 402 that can comprise, for example, a USB cable. The impact location information can be utilized by computer 250 located in projector cabinet 220 that also houses projector 210. The computer 250 can use the impact location information to simulate an augmented reality impact where an object such as a throwing axe located at the same position as the contact of the object with the pervious screen 120. In this way, the foam axe, which is safe, can appear to lodge itself into the projected target 140 which can take the form of a wooden target. FIG. 6 shows the axe traversing the pervious screen 120. FIG. 7 shows the augmented reality image, a virtual version of a projected simulated axe impact. Impact animation 142 is shown on pervious screen 120. Impact animation can be a static image that appears on the screen or a dynamic animation including a burst or cloud of dust before resulting in a simulated image of the traverse object, the impact animation 142, embedded in the projected target 140. A projected score 144 can also be displayed in a static or animated fashion. When different targets are successfully hit, special animations or sounds can be displayed or played from light bar 229 and speaker 240 in addition to impact animation 142 to highlight user success or failure and enhance immersion. In this way, the safe, foam axe 500 passes through the screen, but the user sees the impact animation 142 as a simulated image resembling a sharp, metal axe lodged into the target.

The invention presents a novel method of simulating an impact of a traverse object through a pervious screen 120. The system of the invention can simulate, through augmented reality, a traverse object's collision with, impact on, or penetration into, a simulated target.

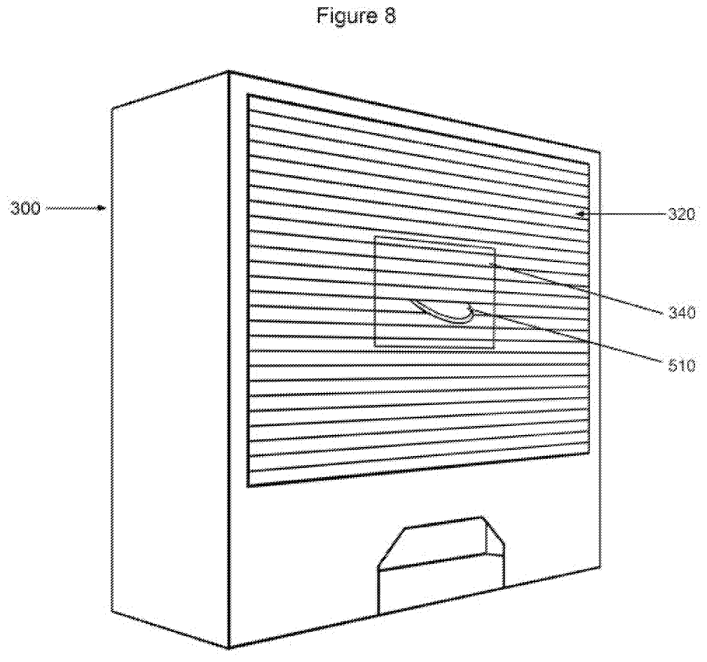

FIG. 8 presents an alternate embodiment of the invention with elastic straps oriented horizontally to create pervious screen 320 mounted within target system 300. Whereas a thrown axe travels with an end over end rotation that presents a vertical profile, a flying disk spins horizontally and presents a horizontal profile. Flying disk 510 is shown traversing pervious screen 320 at projected target 340 which can be a basket, or a box, or other target image. In an embodiment of the invention, a target cabinet can be configured to receive a pair of screen rails in a top and bottom configuration or a left and right configuration interchangeably to allow for different games to be played. Computer 250 can be programmed to project a variety of different static and moving targets to provide, for example, an augmented reality “disc golf” game (aka frisbee golf) where the scenery and targets can change, but the game can be played in a small, indoor environment.

Darts can be used with simulated static or moving targets and safe, plastic darts can be used with a target system with a vertical or horizontal elastic strap orientation.

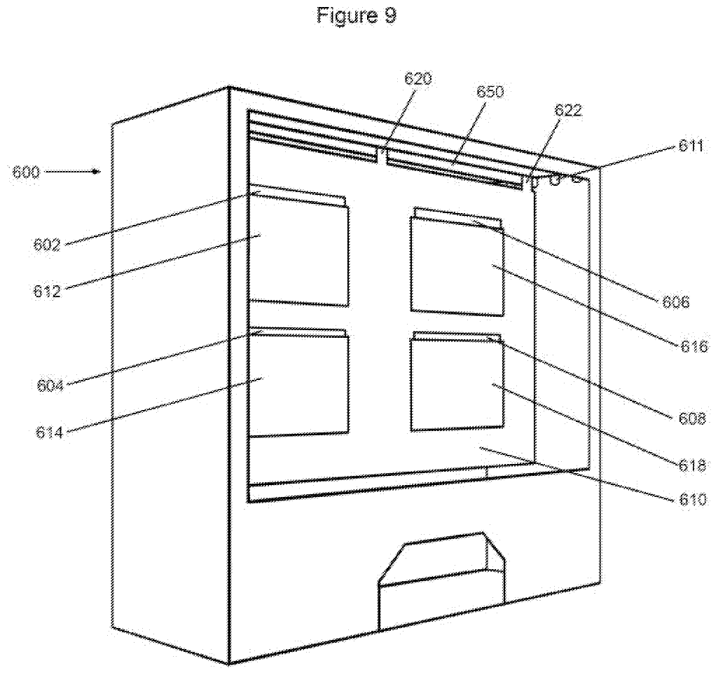

FIG. 9 shows an alternate embodiment of the invention with multiple detector frames to provide a large target area that can provide a shooting gallery or other multiple target game. Target system 600 is presented with four detector frames supported by curtain 610. First detector frame 602, second detector frame 604, third detector frame 606, and fourth detector frame 608 can be connected to computer 250 to enable the playing of games on a larger format pervious screen (not shown). This target system can utilize a pervious screen as detailed in previous embodiments such as pervious screen 120. Top curtain rail 650 can be fed through loops of curtain 610 such as first curtain loop 620 and second curtain loop 622 and inserted into a structural support such as second curtain notch 611. First curtain notch (not numbered) is shown receiving one end of top curtain rail 650 in FIG. 9. Other positions can be utilized to position the curtain closer to the front of the cabinet. Curtain 610 can be configured with fabric pockets to support and suspend the detector frames in desired locations. In the embodiment shown in FIG. 9, detector frames are placed in one particular configuration. Other configurations are available in the spirit of the invention.

First detector 602 is disposed in first pocket 612, second detector 604 is disposed in second pocket 614, third detector 606 is disposed in third pocket 616, and fourth detector 608 is shown as disposed in fourth pocket 618. A traverse object impacting curtain 610 will be detected by a detector frame if it is aimed to impact within one of the detector frames. Visual target fields on a large pervious screen can coincide with multiple detector frames creating active target sectors. A large screen experience can be provided where active target opportunities are located in the active target sectors. For example, a shooting gallery can provide bottles and cans on a bar and on shelves. The foreground can overlap lower targets projected in front of second detector frame 604, and the background or items on shelves can overlap upper targets projected in front of first detector frame 602. Other games can be played with the same system. Compressed air guns can shoot foam balls through a pervious screen that can be detected by first detector frame 602 to determine the impact location and the computer 250 can generate an impact animation, image, or series of images, such as a glass bottle breaking with accompanying sounds from speaker 240 to provide a convincing augmented reality experience. In this way, the user can achieve the visceral feedback of a powerful weapon while shooting a foam ball that is not dangerous.

The pervious screen 120 adds to the immersion of the experience because the foam axe, or foam projectile disappears and is replaced by an impact animation that convinces the user that a real, impactful result has occurred.

In an alternate embodiment, the projected target 140 can take the form of a set of bowling pins that can be struck with a throwing axe, or a ball from a gun, or any manner of objects cast at the target system 100 by a user. A large number of variations of games are possible.

Any description of a component or embodiment herein also includes hardware, software, and configurations which already exist in the prior art and may be necessary to the operation of such component(s) or embodiment(s). Further, the operations described herein can be performed in any sensible order. Any operations not required for proper operation can be optional. Further, all methods described herein can also be stored on a computer readable storage to control a computer.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An augmented reality game system comprising:
a target system and a projector system;
said target system comprises a pervious screen disposed within a target cabinet and a detector frame disposed within said target cabinet and adjacent said pervious screen;
said projector system comprises a computer in communication with a projector, and said computer provides an image signal to said projector, and said projector projects a projected target image upon said pervious screen;
said pervious screen comprises a plurality of contiguous elastic members; and
said detector frame determines an impact location of a traverse object contacting said pervious screen.

2. The augmented reality game system of claim 1 wherein said plurality of contiguous elastic members comprises elastic straps.

3. The augmented reality game system of claim 1 wherein said plurality of contiguous elastic members is each attached to a first screen rail at an elastic strap first end and attached to a second screen rail at an elastic strap second end;
said first screen rail is attached to said target cabinet and said second screen rail is attached to said target cabinet where said first screen rail and said second screen rail are spaced apart sufficient to tension said plurality of contiguous elastic members.

4. The augmented reality game system of claim 3 wherein said plurality of contiguous elastic members are oriented vertically.

5. The augmented reality game system of claim 3 wherein said plurality of contiguous elastic members are oriented horizontally.

6. The augmented reality game system of claim 1 wherein said pervious screen is configured to provide a flat surface to receive said projected target image from said projector and said detector frame surrounds said projected target;
said detector frame is in communication with said computer and communicates said impact location;
said computer generates an impact animation and communicates said impact animation to said projector; and
said projector projects said impact animation onto said pervious screen at said impact location to simulate an augmented reality impact of said traverse object with said projected target.

7. The augmented reality game system of claim 6 wherein said target cabinet comprises a target opening, said pervious screen is positioned within said target opening, and said detector frame is positioned around said target opening to detect passage of said traverse object into said target opening.

8. The augmented reality game system of claim 6 wherein said projector system further comprises:
a projector cabinet;
a user interface disposed in said projector cabinet and in communication with said computer; and
said user interface communicates information about said impact location to a user;

9. A game system comprising:
a target cabinet and a computer;
a first detector frame disposed within said target cabinet and in communication with said computer;
a second detector frame disposed within said target cabinet and in communication with said computer;
a pervious screen positioned in front of said first detector and said second detector;
a projector connected to said computer and configured to produce a projected target image comprising a first target and a second target on said pervious screen wherein a first target is displayed over said first detector frame and a second target is displayed over said second detector frame;
wherein said first detector frame can detect an impact location of a traverse object when coinciding with said first target and said second detector frame can detect said impact location of said traverse object when coinciding with said second target; and
said computer generates an impact animation for display at said impact location.

10. The game system of claim 9 wherein said impact animation is a virtual version of said traverse object that simulates interaction of said traverse object with said first target or said second target produced by said projector.

11. The game system of claim 9 wherein said pervious screen comprises a plurality of contiguous elastic straps under tension and extending from a first screen rail to a second screen rail.

12. The game system of claim 11 wherein said targeting cabinet comprises a curtain comprising a first pocket and a second pocket; and
said first detector frame is disposed in said first pocket and said second detector frame is disposed in said second pocket.
